(19) United States
(12) Patent Application Publication
(10) Pub. No.: US 2008/0217029 A1
(43) Pub. Date: Sep. 11, 2008

(54) Airplane fire fighting thermal barrier and terror threat solution

(75) Inventors: John Anthony Bugel, Largo, FL (US); James Alman, St. Petersburg, FL (US); Kamran Rouhani, Palm Harbor, FL (US)

Correspondence Address: John A. Bugel, PE, 10601 Yunker Drive, Largo, FL, 33774, US

(73) Assignee: Aviation Engineering Consultants, Inc., Clearwater, FL (US)

(21) Appl. No.: 12/073,576

(22) Filed: Mar. 6, 2008

Related U.S. Application Data
(60) Provisional application No. 60/905,352, filed on Mar. 7, 2007.

(51) Int. Cl. A62C 2/06; A62C 3/07

(52) U.S. Cl. 169/48; 169/62

(57) ABSTRACT

A thermal barrier that allows a crew member or passenger to cover an item that is on fire inside an airplane (or other transport vehicle) cabin and carry it to a controlled area, such as a lavatory, where it can burn out, and the gaseous products of combustion (vapors) are exited outside of the aircraft (or other transport vehicle), providing time for the pilot/engineer/operator to make a safe decision concerning continuance of the flight or passage. If not put into a controlled area, item fire may produce poisonous and/or irritating gases that if not removed will recirculate throughout the entire cabin harming all the occupants. Burning item may cause structural damage to the aircraft (or other transport vehicle) creating an unsafe flight or passage.

### CROSS REFERENCE TO RELATED APPLICATIONS (US PATENT DOCUMENTS)

Parent Case Text

| | | |
|---|---|---|
| 50501284 | March 1996 | Clodfelter/Botteri |
| 5040611 | August 1991 | Steel |
| 6739400 | May 2004 | Lessi/Vanddroux |
| 6619404 | September 2003 | Grabow |
| 4726426 | February 1998 | Miller |
| 6676081 | January 2004 | Grabow |
| 6601653 | August 2003 | Grabow |

This application claims the benefit of the Mar. 7, 2007, filing date of U.S. Provisional Patent Application No. US 60/905,352, titled AIRPLANE FIRE FIGHTING THERMAL BARRIER AND TERROR THREAT SOLUTION, dated Mar. 6, 2007.

### BACKGROUND OF THE INVENTION

1. Field of the Invention

This invention relates to a design for a thermal barrier device. More particularly, the present invention relates to a device that covers and allows capture of a burning item, such that a person may pick the burning item up without harm and carry it to a controlled location.

2. Prior Art

Currently airplane cabin fires are extinguished with Halon 1211 or equivalent fire extinguishers. The number and type of extinguishers are determined on commercial aircraft per FAA FAR 25.851. Halon is in itself toxic to humans, but is considered safe if the concentration in the air is kept below 9%. Halon is ineffective in extinguishing lithium fires. The FAA tested a number of lithium batteries and documented the results in their report Flammability Assessment of Bulk-Packaged, Nonrechargeable Lithium Primary Batteries in Transport Category Aircraft. Many electronic devices today are powered by lithium batteries. If one of these devices were to catch fire on the airplane (or made to catch fire in a terrorist effort) there would be no effective way to deal with the fire. As noted in the FAA report, a lithium battery fire can exceed 1400° F., a temperature which is above the melting temperature of many of the aircraft's structural components. The report also noted that when the lithium batteries burn they emit hot molten lithium metal sparks and toxic gases. The only alternative is to just let the batteries burn up. To expand this scenario further a number of batteries could be combined by terrorist forces and purposefully ignited in an effort to injure passengers, cause damage to the aircraft, or just to cause enough of a distraction to allow them to take control of the airplane. If a large enough battery or a group of batteries caught on fire, the heat generated is sufficient to burn through the airplane deck and damage the flight control structures below, creating a safety hazard to the airplane and its passengers. Even worse the burning item can burn into fuel lines and fuel tanks, resulting in catastrophic damage to the aircraft and all those on board.

The product of this patent can also be applied to other transport vehicles, such as, but not limited to, trains and boats where people are in an enclosed space and the exposure to such fires can pose a danger to the occupants.

### SUMMARY OF THE INVENTION

Due to the shortcomings of the prior art, it is an objective of the present invention to provide a method of moving the problem item (the burning device) to an area where the vapor products of combustion can be evacuated overboard and the burning item cannot damage adjacent airplane (or other transport vehicle) structures or harm passengers. The thermal barrier will be wrapped around or enclose the burning item and will allow the burning item to be safely hand carried to a lavatory and put into a stainless steel toilet. The toilet will contain burning item and greatly reduce heat transfer to sensitive airplane (or other transport vehicle) structures. The lavatory door will be closed to eliminate diffusion of combustion products into the cabin. The lavatory air is expelled overboard.

### BRIEF DESCRIPTION OF SEVERAL VIEWS OF THE DRAWINGS

The Blanket Drawing shows various views of one embodiment of the present invention—a blanket.

FIG. 1 is the plane front view,

FIG. 2 is the side view,

FIG. 3 is a section view taken from the front view,

FIG. 4 is a detail view of one end of the section view showing the mat and cover, and

FIG. 5 is an isometric view

The Bag Drawing shows various views of another embodiment of the present invention—a bag.

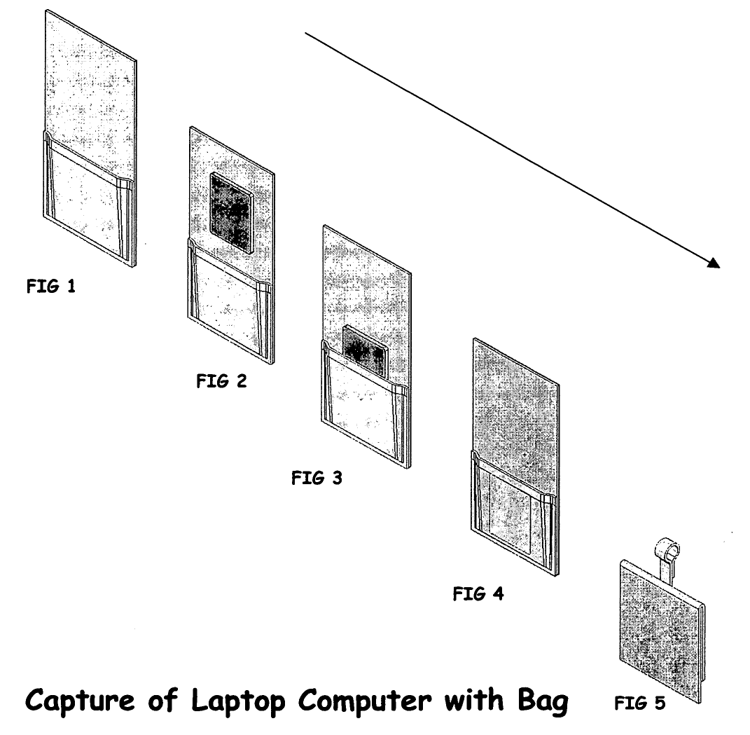

FIG. 1 is a side view,

FIG. 2 is the front view,

FIG. 3 is the back view,

FIG. 4 is a section view of FIG. 3,

FIG. 5 is a detail view of one end of the section view,

FIG. 6 is a front isometric view and

FIG. 7 is a back isometric view.

### DETAILED DESCRIPTION OF THE INVENTION

The Blanket Drawing shows a number of views of one embodiment of the thermal barrier—a blanket. Item 1 is the thermal barrier blanket in its entirety. Its thickness varies with the application from 1/16th inch to 3 inches. Its other dimensions can vary from one inch by one inch to 100 feet by one inch to 100 feet or larger. The thermal barrier is composed of three components. An inner mat, item 2, that provides the thermal barrier. It is enclosed by an outer cover, item 3, to isolate the mat from the user. The cover is mechanically coupled together at its ends by item 4 so that no part of the mat can be exposed to the user.

One source of the material for item 2 would be the ceramic mat material the like and kind that is used in the HVAC industry for fire barriers in kitchen exhaust ducts (chimneys). The cover, item 3, material could be ceramic cloth. And the joining media, item 4, material could be ceramic thread, metal staples or adhesives. At present all three components are composed of materials that can withstand temperatures of 1800° F. and will not ignite and burn from contact with the burning item. The barrier is not limited to just 1800° F. The withstanding temperature of the barrier can be increased by design and alternate material selection to allow containment of higher temperature burning items. The thermal barrier is flexible so that it can be folded up and stowed conveniently on board the aircraft (or other transport vehicle) at several locations. It is also flexible so that it can be wrapped around or enclose a burning object. Drawing Capture of Laptop Computer with Blanket shows a scenario in which the blanket would be used to capture and contain a burning 17 inch laptop computer.

The first view of Drawing Capture of Laptop Computer with Blanket (view FIG. 1) shows the blanket opened from its packaging and under the burning laptop computer. In an actual situation the computer would be under the blanket, allowing the blanket to provide a barrier between the user and the burning item. The laptop is shown on top to allow the reader to visualize its position against the blanket. The second view of Drawing Capture of Laptop Computer with Blanket (view FIG. 2) shows the blanket folded twice at opposite edges. This configuration leaves two openings in the blanket that is exposed to the burning object. The 3^{rd} view of Drawing Capture of Laptop Computer with Blanket (view FIG. 3) shows the other two ends of the blanket, one end fold on top and one end folded on the bottom to fully enclose the burning object. In this configuration the burning object and blanket can be carried to a safe location where the object is free to burn out without harming the airplane or other transport vehicle and its passengers.

The thermal barrier can be a simple flat shape such as a blanket or an assembly of shapes configured and joined together into, but not limited to, a pocketed item (such as a bag), an apron, or hand gloves. The Bag Drawing is one such item, a bag. A number of views of the bag is shown in the Bag Drawing.

The Bag Drawing shows a bag (item 1) composed of a front barrier (item 3), a back barrier (item 5), and joining material (item 8). Springs, item 9, may be added at the sides of the bag opening, when necessary, to aid in bag opening. Each barrier, items 3 & 5, would be constructed as described in the Blanket Drawing. The back barrier item 3 is composed of three components, an inner mat, item 2, that provides the thermal barrier, an outer cover, item 3, to isolate the mat from the user, and a joining material, item 8, to attach the ends of the cover to each other and fully enclose the mat. In like manner the front barrier item 5 is composed of three components, an inner mat, item 6, that provides the thermal barrier, an outer cover, item 7, to isolate the mat from the user, and a joining material, item 8, to attach the ends of the cover to each other and fully enclose the mat. The two barriers would be joined together along the side and bottom edges with flameproof material such as ceramic thread or with some other type of flameproof fastener, to create an enclosure that would thermally isolate and contain the burning object. The back barrier, item 3, is larger than the front barrier item 5, so as to allow the back barrier to grab the burning object and guide it into the space between the front and back barriers. Springs, item 9, can be added to the bag to insure that the barriers separate at the top and allow passage of the burning item into the space between them. The back barrier would then be folded over against the front barrier to enclose the burning object and allow it to be safely carried off to a controlled location. Drawing Capture of Laptop Computer shows a scenario in which the bag would be used to capture and contain a burning 17 inch laptop computer.

The first view of Drawing Capture of Laptop Computer with Bag (view FIG. 1) shows the bag opened from its packaging and upright. View FIG. 2 shows the bag with the burning laptop computer against the top front of the rear barrier. Computer would be in this position by the user laying the rear barrier top front surface against the burning object and using the excess rear barrier on the sides to grasp and hold the burning object. The bag could be further improved to add pocketed hand holes to contain and fully protect the user's hands. View FIG. 3 shows the computer being guided into the pocket between the front and rear barriers. View FIG. 4 shows the computer fully in the pocket. View FIG. 5 shows the top of the rear barrier folded over the front barrier closing off the opening between the front and rear barriers. Attachment features could be added to the contacting surfaces to insure closure of the bag. The bag may also incorporate a handle to allow the bag to be carried low to the ground where there is less danger to the passengers on it's way to a safe place.

What is claimed

1. A system to control a fire in the occupied spaces of an aircraft or other transport vehicle.

2. The invention according to claim 1, which provides an item that can be safely wrapped around a burning object on board an airplane or other transport vehicle.

3. The invention according to claim 1, which provides a thermal barrier, that when wrapped around a burning item on an airplane (or other transport vehicle), will allow someone to pick up the burning item and carry it without getting burned.

4. The invention according to claim 1, which provides a thermal barrier that when wrapped around a burning item on an airplane (or other transport vehicle) will not ignite or be combustible.

5. The invention according to claim 1, which provides a thermal barrier that when wrapped around a burning item on an airplane (or other transport vehicle) will not produce or will produce only limited products of combustion.

6. The invention according to claim 1, which provides a thermal barrier, that when wrapped around a burning item on an airplane (or other transport vehicle), will have an external temperature that is insufficient to ignite adjacent structures.

7. The invention according to claim 1, which provides an item that can be used to safely grab a burning item on an airplane or other transport vehicle.

8. The invention according to claim 1, which provides an item that can be used to convey a burning item into an enclosure.

9. The invention according to claim 1, which provides an enclosure that a burning object can be put into.

10. The invention according to claim 1, which provides a thermal barrier, that when enclosed around a burning item on an airplane (or other transport vehicle), will allow someone to pick up the burning item and carry it without getting burned.

11. The invention according to claim 1, which provides an item than can control a fire that can not be extinguished by the airplane's current halon or equivalent fire extinguishers.

12. The invention according to claim 1, which provides an item than can control a fire that can not be extinguished by the transport vehicle's current fire extinguishers.

13. The invention according to claim 1, which provides an item that can control and isolate a fire based terror threat to an aircraft or other transport vehicle.
